(19) United States
(12) Patent Application Publication
(10) Pub. No.: US 2012/0157064 A1
(43) Pub. Date: Jun. 21, 2012

(54) METHOD OF PROCESSING INCOMING CALLS IN A COMMUNICATIONS TERMINAL

(75) Inventor: Julian DAUBRAWA, Muenchen (DE)

(73) Assignee: ASTRIUM GMBH, Taufkirchen (DE)

(21) Appl. No.: 13/299,012

(22) Filed: Nov. 17, 2011

(30) Foreign Application Priority Data
Nov. 18, 2010 (DE) DE 102010051545.0

(51) Int. Cl. H04W 4/00; H04M 3/42

(52) U.S. Cl. 455/414.1; 379/201.02

(57) ABSTRACT

Method of processing incoming calls in a communications terminal. The method includes determining whether a caller ID of the calling communications terminal is an admissible caller ID, determining whether a time at which the call is received from the other communication subscriber meets a predetermined time criterion, and signaling the call on the communications terminal when both the caller ID is admissible and the time criterion is met.

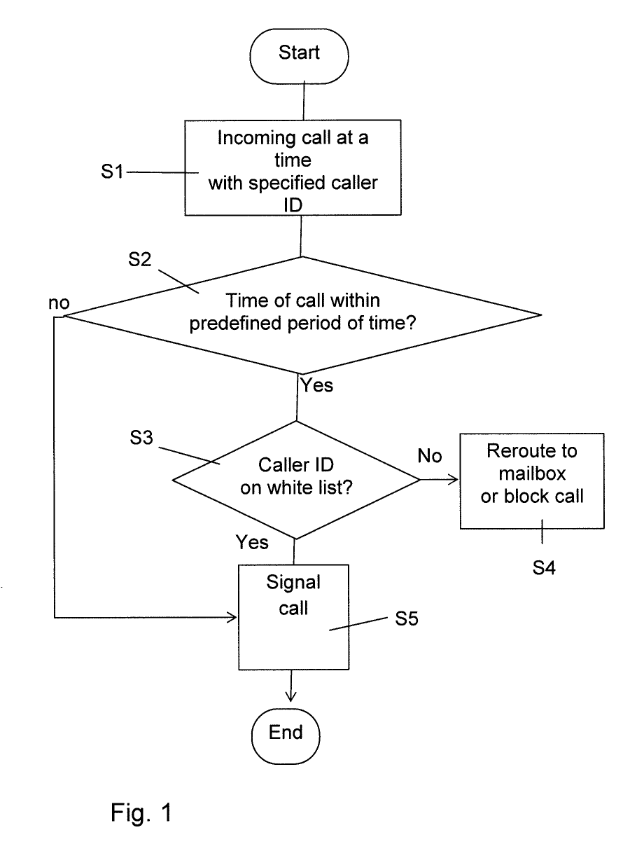

### CROSS-REFERENCE TO RELATED APPLICATIONS

The present application claims priority under 35 U.S.C. §119 of German Patent Application No. DE 10 2010 051 545.0, filed on Nov. 18, 2010, the disclosure of which is expressly incorporated by reference herein in its entirety.

### BACKGROUND OF THE INVENTION

1. Field of the Invention

Embodiments of the invention relate to a method of processing incoming calls in a communications terminal, in particular a mobile telephone. The communications terminal is checked for call signaling as to whether the caller ID of the calling communications terminal is an admissible caller ID by comparing the caller ID of a calling communications terminal with caller IDs contained in a list assigned to the called communications terminal.

2. Discussion of Background Information

A method of this kind normally serves the purpose of suppressing unwanted callers, who are identified by their caller ID (telephone number). Calls of this kind are not signaled at the communication terminal called. For this purpose, welcome caller IDs are entered, for example, in a positive list, a so-called “white list.” When there is a call from a communication terminal that is assigned to this kind of positive list, it is checked whether the caller ID of the calling communication terminal is on the list. If that is the case, the call can be signaled. All other caller IDs not contained in the positive list are blocked. Also known are negative lists (so-called “blacklists”) that enable the selective blocking of unwanted caller IDs in the inverse case. In the case of negative lists, the caller IDs on the list are suppressed.

Positive lists and negative lists can usually be changed with respect to the caller IDs they contain. The modifiable positive list enables users to unlock the communication connection exclusively for fixedly defined caller IDs (telephone numbers, or, as the case may be, blocks of numbers). The modifiable negative list renders possible targeted blocking of caller IDs.

Positive and negative lists are usually used statically, despite the possibility of modification. This means that they are established once and possibly updated at regular or irregular intervals in order to separate unwanted callers from welcome callers. However, these lists do not provide the option of selectively processing caller IDs within the context of specific events, for example, to treat them as admissible caller IDs in one certain situation and as inadmissible caller IDs in another situation.

### SUMMARY OF THE INVENTION

Embodiments of the invention are directed to a method that renders possible a more flexible processing of incoming calls on a communications terminal.

According to embodiments, as part of the method, it is additionally checked whether the time of the call by the other communication subscriber meets a predetermined time criterion, such that the call is signaled only if the caller ID is admissible and the time criterion is met. Advantageous embodiments are described in the dependent claims.

The embodiments create a method of processing incoming calls in a communications terminal, in particular a mobile telephone, in which it is checked for call signaling whether the caller ID of the calling communications terminal is an admissible caller ID by comparing the caller ID of a calling communications terminal with caller IDs contained in a list assigned to the called communications terminal. Additionally, a check is made whether the time of the call by the other communication subscriber meets a predefined time criterion, whereby the call is signaled only if the caller ID is admissible and the time criterion is met.

The method according to the embodiments makes it possible to selectively not signal calls on a communications terminal that are unimportant or unwanted during a specific period of time. Important or welcome calls can still be signaled. Unwanted calls could be, for example, calls that come from unknown persons during the time for sleep. Switching off the communications terminal during the specific period of time could result in important or welcome telephone calls possibly being missed. In contrast to a change in the list of caller IDs that are assigned to the called communications terminal, the time criterion, for example, a specific period of time, can be changed more quickly and with less effort. The cascading of two different criteria makes it possible for certain caller IDs not to be entirely suppressed, but for suppression to be made dependent on a time criterion. In order to block unwanted caller IDs, a user of the communications terminal needs only to activate the time criterion. On the other hand, in the case of the traditionally used positive or negative lists, further unwanted caller IDs would have to be regularly added to the list or removed from it. In contrast, the proposed approach is significantly easier to manage and allows the user of the communications terminal a more flexible handling of incoming calls subject to a given situation.

A predefined time criterion is checked to determine whether the call is received within a predetermined period of time. If calls from unwanted caller IDs (for example, caller IDs that are not on a positive list) are within the predetermined period of time, it is determined that the time criterion is not met, i.e., the call from a calling communications terminal with an unwelcome caller ID is not signaled at the communications terminal receiving the call. The period of time can be, for example, a time for sleep, a conference, and the like.

In an advantageous embodiment, the predetermined period is fixed with respect to its beginning and length by a user of the communications terminal. The active signaling of calls with unwelcome caller IDs can therefore be activated and deactivated in the manner of an “alarm clock.”

The list of caller IDs can be stored, for example, in the called communications terminal. Alternatively, the list of caller IDs can be stored in a computer of the communications network, with the communications terminals being subscribers of the communications network.

In one embodiment, the first list is a positive list (a so-called white list), with which, if the time criterion is met, only those caller IDs are released for call signaling that match those contained in the first list. Two conditions must therefore be met simultaneously for a call to be signaled: the caller ID must be on the list of caller IDs, and the time criterion must be met. Calls with a caller ID that is not on the list of caller IDs will only be signaled if the calls take place outside of the period defined by the time criterion.

The list required for the invention can be valid, for example, from a starting time to an end time, and, can be automatically repeated, for example, when the start time is once again reached.

The list could also be configured as a negative list in an alternative embodiment.

In a further embodiment, the call from the other communications terminal will be rerouted if the time criterion is not met and the caller ID of the calling communications terminal is not an admissible caller ID. By way of example, a rerouting to a mailbox of the communications terminal takes place hereby, so that the user of the calling communications terminal can leave a message for the user of the communications terminal being called.

In a further embodiment, the control of calls depending on time and lists is stored in a profile of the communications terminal. That renders possible an easy activation of the call management according to the invention.

Even though the order in which the two criteria are checked is in principle irrelevant, it is preferred if the checking of the time criterion takes place before the checking of the admissibility of the caller ID of the calling communications terminal. In this variant, the case can especially be taken into consideration, where only the caller IDs that are on a positive list are used for signaling a call if the time criterion is met. In this way, for example, a call during predetermined periods of time is rendered possible for family members and/or friends and/or business partners, etc., whereas all other callers will not be signaled. It is particularly possible in this context to assign several different lists to the communications terminal and to let the user select one or more of the lists, the caller IDs of which are to be admissible during the predetermined period of time.

Embodiments of the invention are directed to a method of processing incoming calls in a communications terminal. The method includes determining whether a caller ID of the calling communications terminal is an admissible caller ID, determining whether a time at which the call is received from the other communication subscriber meets a predetermined time criterion, and signaling the call on the communications terminal when both the caller ID is admissible and the time criterion is met.

According to embodiments, the communications terminal can include a mobile telephone.

In accordance with other embodiments, the determining of the caller ID may include comparing the caller ID of a calling communications terminal with caller IDs contained in a list assigned to the called communications terminal.

Further, the determining of the time can include checking, as a predetermined time criterion, whether the call is within a predetermined period of time. The predetermined period of time may be fixed with respect to its beginning and its length can be defined by a user of the communications terminal.

According to still other embodiments of the invention, a list of caller IDs can be stored in the called communications terminal.

In accordance with further embodiments, a list of caller IDs can be stored in a computer of the communications network. The communications terminals being subscribers of the communications network.

Moreover, a list of caller IDs can be stored as a positive list (white list), such that only those caller IDs that match those contained in the positive list are released for call signaling.

According to further embodiments, the call by the other communications terminal can be rerouted when at least one of the time criterion is not met and the caller ID of the calling communications terminal is not an admissible caller ID. The rerouting takes place to a mailbox of the communications terminal.

In accordance with other embodiments of the invention, a control of calls depending on time and lists may be stored in a profile of the communications terminal.

The checking of the time criterion takes place before the checking of the admissibility of the caller ID of the calling communications terminal.

Embodiments of the invention are directed to a method for processing incoming calls to a communications terminal. The method includes determining whether the incoming call is received within a predetermined time interval, determining whether the caller is an accepted caller, and signaling the incoming call when the incoming call is placed by an accepted caller within the predetermined time interval.

In accordance with still yet other embodiments of the present invention, the method can further include at least one of blocking the call and forwarding the call to a mailbox when at least one of the call is not an accepted caller and the call is received outside of the predetermined time interval.

Other exemplary embodiments and advantages of the present invention may be ascertained by reviewing the present disclosure and the accompanying drawing.

### BRIEF DESCRIPTION OF THE DRAWINGS

The present invention is further described in the detailed description which follows, in reference to the noted drawing by way of non-limiting example of exemplary embodiments of the present invention, and wherein:

The single FIGURE illustrates a flow diagram of an exemplary sequence of the method according to the invention.

### DETAILED DESCRIPTION OF THE EMBODIMENTS

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

The method of incoming calls to a communications terminal according to embodiments of the invention is intended for use in particular with mobile telephones. The method makes it possible to separate unimportant calls from important calls during a specific period of time. Such periods of time could be, for example, meetings, periods for sleep, and the like. According to the method, it is especially possible to avoid missing important or wanted calls as a result of completely switching off the communications terminal during such periods, as was previously necessary.

In order to implement the method according to the invention, the user of the communications terminal creates a list of caller IDs (telephone numbers or blocks of telephone numbers) for other communications terminals that are to be considered welcome callers. The caller IDs are stored on a positive list, which is also known under the term the “white list.” The list of caller IDs can be optionally stored directly in the communications terminal of the user or in a computer of the communication network. In this regard, the communications device of the user and the communications terminals of the calling users are subscribers in the communications network.

The user of the communications terminal furthermore specifies a period of time during which the positive list is to be active. The period of time can be defined either by specifying a start time and an end time or by specifying a start time and a period of time. The definition of the period of time can optionally be stored in the communications terminal of the user or in one of the computers of the communications network.

It is possible to establish the period of time defined by the user as valid only once. Further, the defined period of time can likewise be periodically repeated. The known mechanisms for alarm clocks in communications terminals are thereby available in principle.

A list containing caller IDs that may call during a certain period of time is implemented by these preparatory measures. The sequence of the procedure is now as follows.

In a first step S1, an incoming call from a calling communications terminal takes place at a certain time. With the incoming call, the caller ID, i.e., the telephone number, of the calling communications terminal is transmitted to the called communications terminal.

In a step S2, a determination is made whether the time of the call is within the period of time defined by the user of the called communications terminal. If this is the case (i.e., “yes”), a determination is made according to step S3 whether the caller ID of the calling communications terminal is on the positive list (white list) assigned to the communications terminal called. If that is not the case (i.e., “no”), the call is rerouted to a mailbox of the called communications terminal according to step S4. Alternatively, the call by the calling communications terminal can also be blocked. It would be equally conceivable to not signal the call from the calling communications terminal, but to send an SMS about the call not signaled to the communications terminal being called. On the other hand, if the caller ID of the calling communications terminal is on the positive list (i.e., “yes”), the call is signaled according to step S5. If the decision in step S2 is “no,” the call is also signaled according to step S5.

The steps S2 and S3 could also be taken in the reverse order. What is essential for the method according to the invention is the combined checking of whether a caller ID that is on a positive list takes place or is received during a predefined period of time. Only then is the call signaled.

The advantage of the described method is that during the predefined period of time, only predefined, e.g., important or welcome telephone calls from certain caller IDs or users, are allowed to go through.

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

What is claimed:

1. A method of processing incoming calls in a communications terminal, comprising:
determining whether a caller ID of the calling communications terminal is an admissible caller ID;
determining whether a time at which the call is received from the other communication subscriber meets a predetermined time criterion; and
signaling the call on the communications terminal when both the caller ID is admissible and the time criterion is met.

2. The method according to claim 1, wherein the communications terminal comprises a mobile telephone.

3. The method according to claim 1, wherein the determining of the caller ID comprises comparing the caller ID of a calling communications terminal with caller IDs contained in a list assigned to the called communications terminal.

4. The method according to claim 1, wherein the determining of the time comprises checking, as a predetermined time criterion, whether the call is within a predetermined period of time.

5. The method according to claim 4, wherein the predetermined period of time is fixed with respect to its beginning and its length defined by a user of the communications terminal.

6. The method according to claim 1, wherein a list of caller IDs is stored in the called communications terminal.

7. The method according to claim 1, wherein a list of caller IDs is stored in a computer of the communications network, the communications terminals being subscribers of the communications network.

8. The method according to claim 1, wherein a list of caller IDs is stored as a positive list (white list), such that only those caller IDs that match those contained in the positive list are released for call signaling.

9. The method according to claim 1, wherein the call by the other communications terminal is rerouted when at least one of the time criterion is not met and the caller ID of the calling communications terminal is not an admissible caller ID.

10. The method according to claim 9, wherein the rerouting takes place to a mailbox of the communications terminal.

11. The method according to claim 1, wherein a control of calls depending on time and lists is stored in a profile of the communications terminal.

12. The method according to claim 1, wherein the checking of the time criterion takes place before the checking of the admissibility of the caller ID of the calling communications terminal.

13. A method for processing incoming calls to a communications terminal, comprising:
determining whether the incoming call is received within a predetermined time interval;
determining whether the caller is an accepted caller; and
signaling the incoming call when the incoming call is placed by an accepted caller within the predetermined time interval.

14. The method according to claim 13, further comprising at least one of blocking the call and forwarding the call to a mailbox when at least one of the calls is not an accepted caller and the call is received outside of the predetermined time interval.
